(19) United States
(12) Patent Application Publication
(10) Pub. No.: US 2006/0034180 A1
(43) Pub. Date: Feb. 16, 2006

(54) Cable adapter port module

(76) Inventors: David Gellerman, Urbana, MD (US); Robert F. Gellerman, (US); Tilman Foust, Gaithersburg, MD (US); Vernon May, McKinney, TX (US); George Bailey, Gaithersburg, MD (US); Richard Stilwell, Germantown, MD (US)

Correspondence Address: KATTEN MUCHIN ROSENMAN LLP, 525 WEST MONROE STREET, CHICAGO, IL, 60661-3693, US

(21) Appl. No.: 10/938,948

(22) Filed: Sep. 13, 2004

Related U.S. Application Data
(60) Provisional application No. 60/592,192, filed on Jul. 30, 2004.

(51) Int. Cl. H04L 12/26

(52) U.S. Cl. 370/241

(57) ABSTRACT

A cable adapter port module (CAPM) for providing test access to communication circuits associated with a digital subscriber line access multiplexer (DSLAM) includes a first plurality of ports for coupling the CAPM to the DSLAM. The CAPM includes a second plurality of ports for coupling the CAPM to a distribution frame (DF). The CAPM includes a selector matrix circuit for switching signals between the DSLAM and the DF. The CAPM includes a controller circuit in communication with the selector matrix circuit for controlling the CAPM. The CAPM receives power signals over a communication link for powering the CAPM. The controller circuit modulates the power signals over the communication link to communicate information signals for testing the communication circuits.

This application claims priority under 35 U.S.C. § 119(e) to U.S. Provisional Application No. 60/592,192, filed on Jul. 30, 2004, the entire content of which is hereby incorporated herein by reference.

### BACKGROUND

1. Field of the Invention

The present invention relates to communication circuit testing equipment. More particularly, the present invention relates to a system and method for providing test access to communication circuits associated with a network device.

2. Background Information

With the ever-increasing demand for high-speed network access, improvements and additions to existing network infrastructure are becoming more necessary to meet these demands. As the network infrastructure is improved, equipment density issues can become problematic. For example, rack, shelf and cabinet space to house the network equipment and the concomitant cabling between the various equipment can become scarce as more equipment is added, and the cost to add space and resources to install and house additional equipment can become quite high. To ensure that the network communication circuits are functioning properly, test equipment also needs to be added in these environments to test the communication circuits. However, adding the test equipment to test the network facilities can require numerous additional pieces of equipment and the running of additional cable to support the test access. With existing space limitations, it can become difficult to add such test equipment and cabling in an environment in which space is already at a premium. Thus, given potential rack space and cabinet density problems associated with housing network equipment and the cabling requirements to provide test access to communication circuits coupled to the network equipment, it can become burdensome to add additional test equipment in this environment for testing the communication circuits without adding to cable and equipment density.

Consequently, there is a need for an apparatus that can substantially simplify installation procedures for such test access equipment and reduce installation costs, particularly with respect to the size, length and routing of cabling to support such test access equipment.

### SUMMARY OF THE INVENTION

A system and method are disclosed for providing test access to communication circuits associated with a network device. In accordance with exemplary embodiments of the present invention, according to a first aspect of the present invention, an apparatus for providing test access to communication circuits associated with a network device includes a first plurality of ports. The first plurality of ports are configured to couple the apparatus to the network device. The apparatus includes a second plurality of ports. The second plurality of ports are configured to couple the apparatus to a connection means. The apparatus includes a selector matrix module in communication with the first and second plurality of ports. The selector matrix module is configured to switch signals between the network device and the connection means. The apparatus includes a controller module in communication with the selector matrix module. The apparatus is configured to receive power signals over a communication link for powering the apparatus. The controller module is configured to modulate the power signals over the communication link to communicate information signals for testing the communication circuits.

According to the first aspect, the apparatus can include an interface module in communication with the controller module and the communication link for receiving the power signals and for communicating the information signals from the apparatus. The apparatus can include a system controller. The system controller can be coupled between the apparatus and the at least one test module. The system controller can provide the power signals to the apparatus over the communication link. An information signal communicated between the system controller and the apparatus can comprise a transmission frame. The transmission frame can comprise, for example, at least a command field, an address field, a visual indicator field, a communication circuit identifier field, an access mode field, an error detection/correction field, an event timing field and an apparatus response field. The information signal communicated between the system controller and the apparatus can comprise a start of transmission frame flag. The system controller can include a power controller and communication interface module for providing power to the apparatus and for modulating the power signals to communicate the information signals to the apparatus. The system controller can include a test bus matrix module for connecting one of the at least one test device to the apparatus.

According to the first aspect, the information signals received over the communication link can comprise pulse-width modulated power signals. The controller module can be configured to generate a signal for increasing a current load on the power signals received by the apparatus to modulate the information signals for transmission from the apparatus. The controller module can comprise a programmable logic device. The apparatus can include a connector module for providing programmable access control to the programmable logic device. The apparatus can include a power converter module for converting the modulated power signals to supply power to the apparatus. The apparatus can include an access mode selection module for selecting one of a plurality of access modes of the apparatus. The plurality of access modes can comprise a split access mode, an AC monitor access mode and a DC monitor access mode. The apparatus can include a circuit protection module for protecting the apparatus from power transients. The apparatus can also include a monitor transformer. According to an exemplary embodiment of the first aspect, the network device can comprise a digital subscriber line access multiplexer (DSLAM), and the connection means can couple the apparatus through a main distribution frame towards an end user.

According to a second aspect of the present invention, a system for providing test access to communication circuits associated with network devices includes at least one port module. Each port module includes at least one of a first port configured to connect the port module to a network device. Each port module includes at least one of a second port configured to connect the port module to a connection means. Each port module includes a selector matrix circuit in communication with the first and second ports configured to switch signals between the network device and the connection means. Each port module includes a port module controller in communication with the selector matrix circuit. The system includes a system controller in communication with at least one test device and each port module. The system controller is configured to provide power signals to each port module over a respective communication link and for modulating the power signals to communicate information signals to each port module for testing the communication circuits.

According to the second aspect, each port module can include an interface circuit in communication with the port module controller and a communication link for receiving the power signals and for communicating the information signals from the port module. An information signal communicated between the system controller and each port module can comprise a transmission frame. For example, the transmission frame can comprise at least a command field, an address field, a visual indicator field, a communication circuit identifier field, an access mode field, an error detection/correction field, an event timing field and a port module response field. The information signal communicated between the system controller and each port module can comprise a start of transmission frame flag. The system controller can comprise a test device matrix circuit for connecting one of the at least one test device to a port module. The information signals communicated over the communication link by the system controller can comprise pulse-width modulated power signals. The port module controller can be configured to generate a signal for increasing a current load on the power signals received from the system controller over the communication link to modulate the information signals for transmission to the system controller. The port module controller of each port module can comprise a programmable logic device. Each port module can comprise a connector circuit for providing programmable access control to the programmable logic device.

According to the second aspect, each port module can comprise a power converter for converting the modulated power signals received from the system controller to supply power to the port module. Each port module can comprise an access mode selector for selecting one of a plurality of access modes of the port module. The plurality of access modes can comprise a split access mode, an AC monitor access mode and a DC monitor access mode. Each port module can comprise a circuit protector for protecting the port module from power transients. Each port module can comprise a monitor transformer. According to an exemplary embodiment of the second aspect, the network devices can comprise DSLAMs, and the connection means of each port module can couple the port module through a main distribution frame towards an end user.

According to a third aspect of the present invention, an apparatus for providing test access to communication circuits associated with a network device includes a first plurality of port means for coupling the apparatus to the network device. The apparatus includes a second plurality of port means for coupling the apparatus to a connection means. The apparatus includes a selector means in communication with the first and second plurality of port means for switching signals between the network device and the connection means. The apparatus includes a controller means in communication with the selector means for controlling the apparatus. The apparatus is configured to receive power signals over a communication link for powering the apparatus. The controller means is configured to modulate the power signals over the communication link to communicate information signals for testing the communication circuits.

According to the third aspect, the apparatus can include an interface means in communication with the controller means and the communication link for receiving the power signals and for communicating the information signals from the apparatus. The apparatus can include a system controller means for providing the power signals to the apparatus over the communication link. The system controller module is coupled between the apparatus and the at least one test means. An information signal communicated between the system controller means and the apparatus can comprise a transmission frame. For example, the transmission frame can comprise at least a command field, an address field, a visual indicator field, a communication circuit identifier field, an access mode field, an error detection/correction field, an event timing field and a port module response field. The information signal communicated between the system controller means and the apparatus can comprise a start of transmission frame flag. The system controller means can comprise a power controller and communication interface means for providing power to the apparatus and for modulating the power signals to communicate the information signals to the apparatus. The system controller means can comprise a test bus selector means for connecting one of the at least one test means to the apparatus. The information signals received over the communication link can comprise pulse-width modulated power signals. The controller means can be configured to generate a signal for increasing a current load on the power signals received by the apparatus to modulate the information signals for transmission from the apparatus.

According to the third aspect, the controller means can comprise a programmable logic means. The apparatus can include a connector means for providing programmable access control to the programmable logic means. The apparatus can include a power converter means for converting the modulated power signals to supply power to the apparatus. The apparatus can include an access mode selection means for selecting one of a plurality of access modes of the apparatus. The plurality of access modes can comprise a split access mode, an AC monitor access mode and a DC monitor access mode. The apparatus can include a circuit protection means for protecting the apparatus from power transients. The apparatus can include a monitor means for performing an AC monitor of the apparatus. According to an exemplary embodiment of the third aspect, the network device can comprise a DSLAM, and the connection means of each port module can couple the port module through a main distribution frame towards an end user.

According to a fourth aspect of the present invention, a system for providing test access to communication circuits associated with network devices includes at least one port module means. Each port module means includes at least one of first port means for coupling the port module means to a network device. Each port module means includes at least one of second port means for coupling the apparatus to a connection means. Each port module means includes a selector means in communication with the first and second port means for switching signals between the network device and the connection means. Each port module means includes a port module controller means in communication with the selector means for controlling the port module means. The system includes a system controller means in communication with at least one test means and each port module means for providing power signals to each port module means over a respective communication link and for modulating the power signals to communicate information signals to each port module means for testing the communication circuits.

According to the fourth aspect, each port module means can include an interface means in communication with the port module controller means and a communication link for receiving the power signals and for communicating the information signals from the port module means. An information signal communicated between the system controller means and each port module means can comprise a transmission frame. For example, the transmission frame can comprise at least a command field, an address field, a visual indicator field, a communication circuit identifier field, an access mode field, an error detection/correction field, an event timing field and an apparatus response field. The information signal communicated between the system controller means and each port module means can comprise a start of transmission frame flag. The system controller means can comprise a test selector means for connecting one of the at least one test means to a port module means. The information signals communicated over the communication link by the system controller means can comprise pulse-width modulated power signals. The port module controller means can be configured to generate a signal for increasing a current load on the power signals received from the system controller means to modulate the information signals for transmission to the system controller means.

According to the fourth aspect, each port module controller means can comprise a programmable logic means. Each port module means can comprise a connector means for providing programmable access control to the programmable logic means. Each port module means can comprise a power converter means for converting the modulated power signals received from the system controller means to supply power to the port module means. Each port module means can comprise an access mode selector means for selecting one of a plurality of access modes of the port module means. The plurality of access modes can comprise a split access mode, an AC monitor access mode and a DC monitor access mode. Each port module means can comprise a circuit protection means for protecting the port module means from power transients. Each port module means can comprise a monitor means for performing an AC monitor of the port module means. According to an exemplary embodiment of the fourth aspect, the network devices can comprise DSLAMs, and the connection means can couple the apparatus through a main distribution frame towards an end user.

According to a fifth aspect of the present invention, a method of providing test access to communication circuits associated with a network device includes the steps of: a.) connecting an apparatus to the network device; b.) connecting the apparatus to a connection means; c.) switching signals between the network device and the connection means via the apparatus; d.) receiving power signals at the apparatus over a communication link to power the apparatus; and e.) modulating the power signals over the communication link to communicate information signals for testing the communication circuits.

According to the fifth aspect, an information signal can comprise a transmission frame. For example, the transmission frame can comprise at least a command field, an address field, a visual identifier field, a communication circuit number field, an access mode field, a error detection/correction field, an event timing field and an apparatus response field. The information signal can comprise a start of transmission frame flag. The method can include the step of: f.) coupling one of the at least one test device to the apparatus. The information signals received over the communication link can comprise pulse-width modulated power signals. The method can include the steps of: g.) generating a signal for increasing a current load on the power signals received at the apparatus to modulate the information signals for transmission from the apparatus; h.) converting the modulated power signals to supply power to the apparatus; and i.) selecting one of a plurality of access modes of the apparatus. The plurality of access modes can comprise a split access mode, an AC monitor access mode and a DC monitor access mode. The method can include the step of: j.) protecting the apparatus from power transients. According to an exemplary embodiment of the fifth aspect, the network device can comprise a DSLAM, and the connection means of each port module can couple the port module through a main distribution frame towards an end user.

According to a sixth aspect of the present invention, a port module for providing test access to communication circuits associated with a network element includes at least one of a first port. Each first port is configured to couple the port module to the network element. The port module includes at least one of a second port. Each second port is configured to couple the port module to a connection means. The port module includes a selector matrix circuit in communication with the first and second ports. The selector matrix module is configured to switch signals between the network element and the connection means. The port module includes a controller circuit in communication with the selector matrix circuit. The port module is configured to receive power signals over a communication link for powering the port module. The controller circuit is configured to modulate the power signals over the communication link to communicate information signals for testing the communication circuits.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating a system for providing test access to communication circuits associated with a network device, in accordance with an exemplary embodiment of the present invention.

FIG. 2 is a diagram illustrating an access point relay matrix for supporting up to ninety-six two-wire communication circuits, in accordance with an exemplary embodiment of the present invention.

FIG. 3 is a diagram illustrating a circuit for generating row and column control line signals of the access point relay matrix, in accordance with an exemplary embodiment of the present invention.

FIGS. 4A and 4B are diagrams illustrating exemplary circuit designs for high-side and low-side relay drivers, respectively, used by a port module, in accordance with an exemplary embodiment of the present invention.

FIG. 5 is a diagram illustrating an exemplary 32-bit transmission frame, in accordance with an exemplary embodiment of the present invention.

FIG. 6 is a timing diagram illustrating the timing of the communication of transmission frames, in accordance with an exemplary embodiment of the present invention

FIG. 7 is a flowchart illustrating steps for providing test access to communication circuits associated with a network device, in accordance with an exemplary embodiment of the present invention.

### DETAILED DESCRIPTION OF THE PREFERRED EMBODIMENTS

Exemplary embodiments of the present invention are directed to a system and method for providing test access to communication circuits associated with a network device. According to exemplary embodiments, a Cable Adapter Port Module (CAPM) and an associated system controller can be used as a metallic access device for Digital Subscriber Loop (DSL) circuits and the like. Taking advantage of the space left over by the recessed back (front) plane where distribution frame (DF) cables connect to a Digital Subscriber Line Access Multiplexer (DSLAM), the CAPM can use an in-line design that does not extend beyond the width and height of the existing cabling and cable connector volume allowance of the DSLAM. The CAPM can be connected between the DSLAM and, for example, the DF as a type of cable connector or interconnection. However, the CAPM is configured to provide test access to the communication circuits with minimal space and cabling requirements.

According to exemplary embodiments, the CAPM receives power signals from an associated system controller over a communication link. The system controller is also connected to one or more test equipment devices for testing the communication circuits. The CAPM and system controller communicate information signals between each other over the communication link by modulating the power signals. The communication circuits can then be tested by passing test signals, command signals and other information signals from the test equipment through the system controller and the CAPM (and on to the network equipment and communication circuits) by modulating the power signals passed between the system controller and the CAPM. Consequently, the CAPM can provide test access to communication circuits without taking any rack space and without incurring any communication circuit cable or cable routing costs.

As used herein, a “communication circuit” can be any suitable type of communication circuit, such as, for example, POTS (Plain Old Telephone Service) or any of the different variants of DSL technologies for transmitting high-bandwidth information over twisted-pair (i.e., copper wire) telephone lines, including, for example, ADSL, including ADSL2, ADSL2+ and ADSL2++, ADL ADSL, SDSL, HDSL, VDSL, VDSL2, RADSL, UDSL, CDSL, G.Lite or DSL Lite, IDSL, and any other variant of DSL (such as, for example, EC-ADSL, SHDSL, ESHDSL, 10MDSL, 100MDSL (DSM), M2DSL, BDSL, READSL (LDSL), ReachDSL and MMDSL), all collectively referred to as “xDSL.”

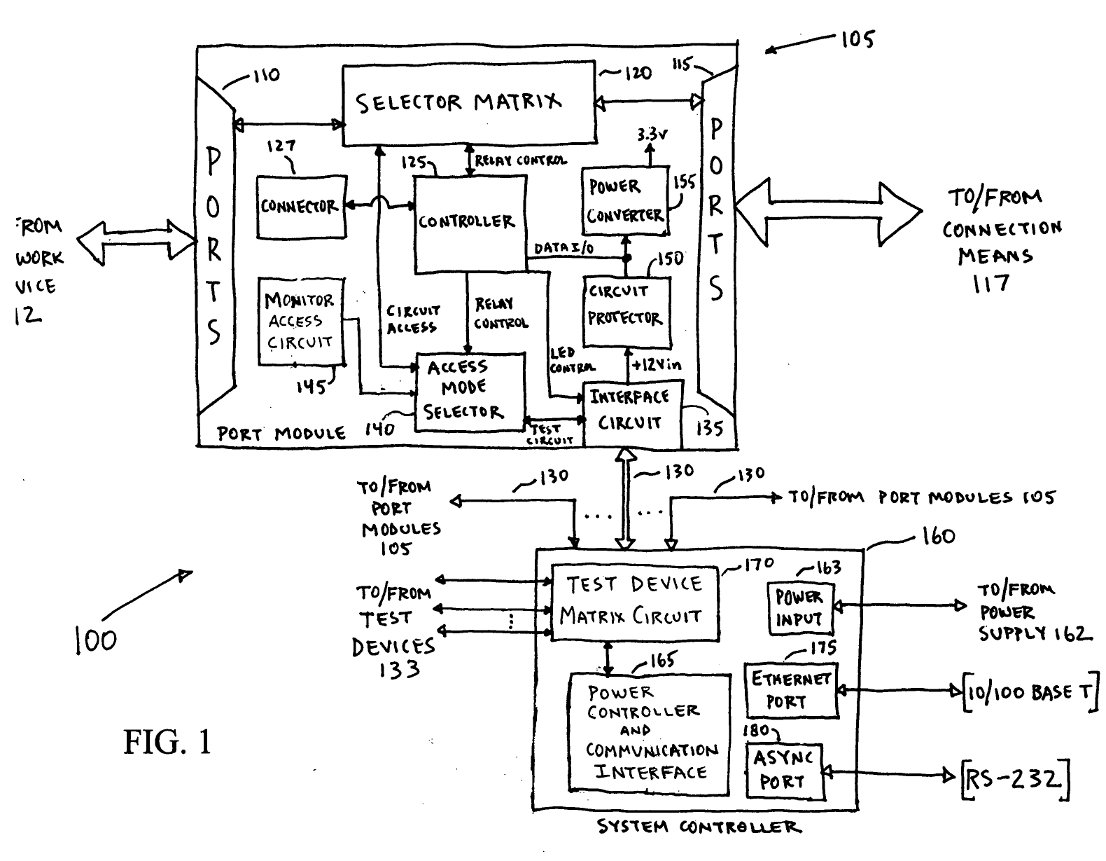

These and other aspects of the present invention will now be described in greater detail. FIG. 1 is a diagram illustrating a system 100 for providing test access to communication circuits associated with a network device, in accordance with an exemplary embodiment of the present invention. The system 100 includes one or more CAPMs, such as, for example, port modules 105. According to an exemplary embodiment, each port module 105 can provide a single access from up to ninety-six two-wire (tip and ring leads) communication circuits, although access to any number of communication circuits can be provided. Although any number of port modules 105 can be deployed in the system 100, according to one exemplary embodiment, up to twenty port modules 105 can be deployed in the system 100. The port modules 105 can be daisy-chained together, if desired.

The port module 105 includes a first plurality of ports 110. The first plurality of ports 110 is configured to couple the port module 105 to a network device 112 (referred to herein as the “equipment side”). The port module 105 also includes a second plurality of ports 115. The second plurality of ports 115 is configured to couple the port module 105 to a connection means 117 (referred to herein as the “facility side”). Any suitable type of electrical connection or connector can be used for the first and second plurality of ports 110 and 115. For example, the first plurality of ports 110 can be comprised of four 25-pair (male) CHAMP-type connectors, three 32-pair (male) CHAMP-type connectors, or any other suitable type of electrical connections. For example, the second plurality of ports 115 can be comprised of four 25-pair (female) CHAMP-type connectors, three 32-pair (female) CHAMP-type connectors, or any other suitable type of electrical connections. Each of the first and second plurality of ports 110, 115 can be comprised of any number of ports.

The port module 105 includes a selector matrix circuit 120 in communication with the first and second plurality of ports 110, 115. The selector matrix circuit 120 is configured to switch signals between the network device 112 and the connection means 117. The port module 105 also includes a controller circuit 125 in communication with selector matrix circuit 120. The controller circuit 125 can be comprised of, for example, a programmable logic device (PLD), such as, for example, an Altera 3128 CPLD or the like. The controller circuit 125 can be used for all interface, control, timing and memory functions of the port module 105, including reception and interpretation of commands, and to set the mode selection and access relays accordingly. The port module 105 can include a connector circuit 127, such as a standard JTAG connector or the like, for providing access to in-circuit programming functions of the controller circuit 125.

According to exemplary embodiments, the port module 105 is configured to receive power signals over a communication link portion of a system link 130 for powering the port module 105. Additionally, the controller circuit 125 is configured to modulate the power signals over the communication link portion of the system link 130 to facilitate communication of information signals for purposes of testing the communication circuits.

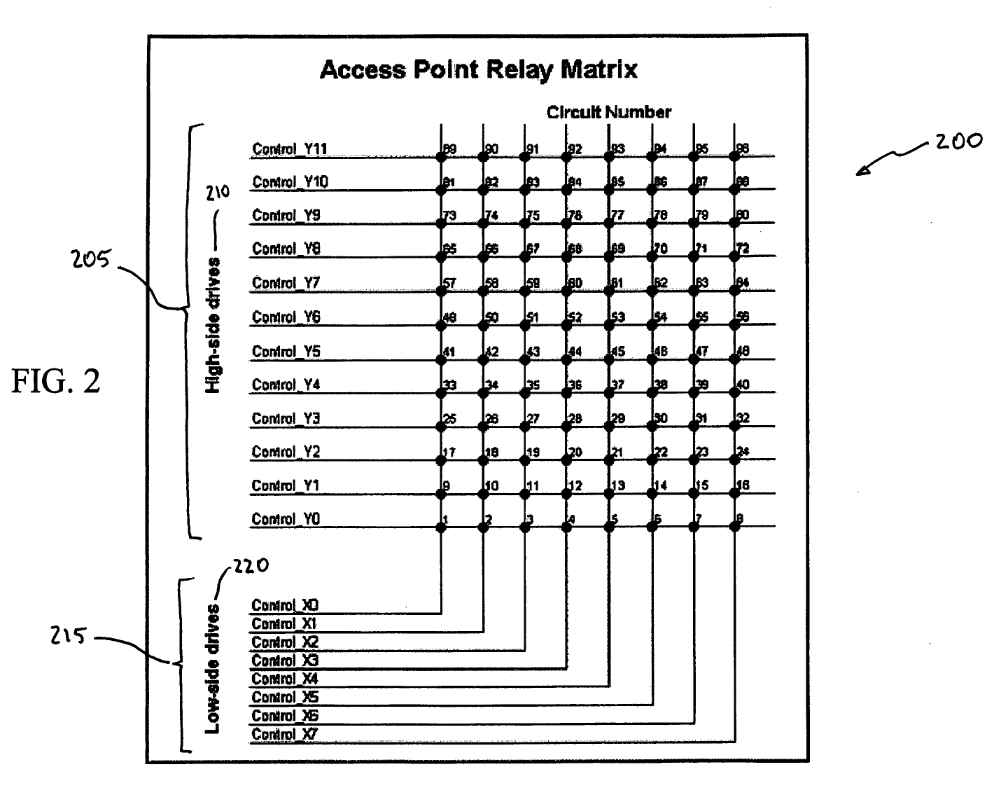

According to exemplary embodiments, the port module 105 uses a matrix scheme for activating the communication circuit selection relays. For purposes of illustration and not limitation, FIG. 2 is a diagram illustrating an access point relay matrix 200 for supporting up to ninety-six two-wire communication circuits, in accordance with an exemplary embodiment of the present invention. The matrix 200 can be arranged in a 8×12 pattern. The row control lines 205 of the matrix 200 can be generated by a high-side driver 210 (e.g., P-channel FET or the like) and can connect to the positive side of the relay coils. The column control lines 215 of the matrix 200 can be generated by a low-side driver 220 (e.g., a ULN2803 Darlington pair or the like) and can connect to the negative side of the relay coils. Activating a single row control line 205 and a single column control line 215 simultaneously can access a selected communication circuit.

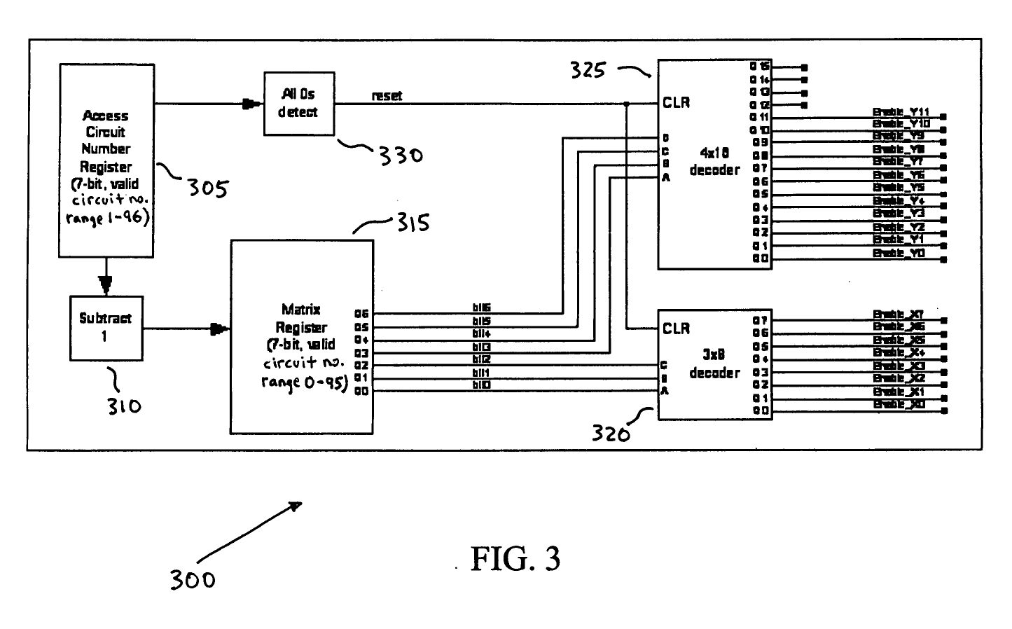

FIG. 3 is a diagram illustrating a circuit 300 for generating the row and column control line 205 and 215 signals of the matrix 200, in accordance with an exemplary embodiment of the present invention. Continuing with the illustration of ninety-six two-wire communication circuits, the address of the communication circuit to be accessed (i.e., communication circuit 1-96) can be stored in, for example, a 7-bit register 305 that can reside in, for example, the controller circuit 125. The communication circuit address number can be reduced by one using a subtraction element 310 in communication with the register 305, giving a resultant circuit number of 0 to 95 (i.e., 000 0000 through 101 1111 in binary). The resulting circuit number can be applied to a 7-bit matrix register 315 in communication with the subtraction element 310. The lowest three bits of the resulting circuit number can be used to select the active column, using a 3×8 decoder 320 in communication with the register 315. The upper four bits of the resulting circuit number can be used to select the row, using a 4×16 decoder 325 also in communication with register 315 (the upper four bits of the decoder 325 can remain unused). According to one embodiment, a special case can exist if the active communication circuit number is zero. Such a case signifies that no communication circuit access is currently being performed. In this situation, if a zero detector 330, in communication with the register 305 and the decoders 320, 325, detects that the communication circuit number is zero, then the zero detector 330 can send an appropriate signal to the decoders 320, 325 to hold the decoders 320, 325 in reset so that no communication circuit relays are asserted.

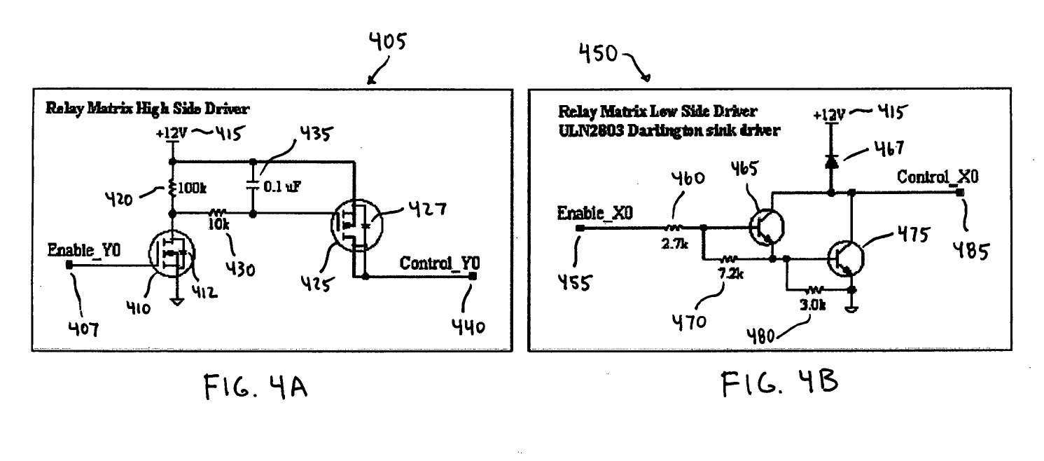

FIGS. 4A and 4B are diagrams illustrating exemplary circuit designs for the high-side and low-side relay drivers 405 and 450, respectively, used by the port module 105, in accordance with an exemplary embodiment of the present invention. In FIG. 4A, for the appropriate row control line 205, a row enable signal 407 is applied to the gate of a first N-channel MOSFET transistor 410, having its source coupled to a reference voltage (e.g., ground) and its source and drain connected across a first internal diode 412. The drain of first transistor 410 is in communication with a voltage source 415 (e.g., +12V DC supplied via the communication link portion of system link 130) through a first resistor 420 (e.g., 100 kΩ). The drain of first transistor 410 is also in communication with the gate of a second P-channel MOSFET transistor 425 through a second resistor 430 (e.g., 10 kΩ). The drain of the second transistor 425 is in communication with the voltage source 415. A capacitor 435 (e.g., 0.1 μF) is in communication between the gate and drain of the second transistor 425. The source of the second transistor 425 (which is also connected to its drain across a second internal diode 427) provides the row control signal 440.

In FIG. 4B, for the appropriate column control line 215, a column enable signal 455 is applied across a first resistor 460 (e.g., 2.7 kΩ) to the base of a first NPN transistor 465. The collector of first NPN transistor 465 is connected to the voltage source 415 through a diode 467. The base of first NPN transistor 465 is connected to its emitter through a second resistor 470 (e.g., 7.2 kΩ), which is in turn in communication with the base of a second NPN transistor 475. The base and the emitter of the second NPN transistor 475 are connected through a third resistor 480 (e.g., 3.0 kΩ), along with the emitter, to a reference voltage (e.g., a ground). The collector of the second NPN transistor 475 is in communication with the collector of the first NPN transistor 465 and the voltage source 415, so as to form, for example, a Darlington pair. The outputs of the collectors of the first and second NPN transistors 465, 475 provide the column control signal 485. Other configurations of the high-side and low-side relay drivers 405 and 450 are possible, as other components and other suitable values of the components can be used. To ensure stored coil energy discharge, without the possibility of damage to the high-side driver, the low-side should be deactivated before the high-side, when releasing a circuit access. An RC circuit can be used on the gate of the P-channel FET of the high-side driver to facilitate this ordering of release should power be removed totally.

The port module 105 includes an interface circuit 135 in communication with the controller circuit 125 and the system link 130 for receiving the power signals and for communicating the information signals from the port module 105. According to an exemplary embodiment, the interface circuit 135 can comprise a single jack of the type used for RJ-45 service or the like, with a single-shielded, CAT 5 Ethernet patch cable (8-conductor) or the like used for the system link 130. The system link 130 can include the leads for the test circuit pairs, as well as the port module's 105 external power supply and ground connections. According to exemplary embodiments, the power supply to the port module 105 over the communication link portion of system link 130 also acts as the information communication medium. For example, although the Ethernet cable includes eight conductors, only six conductors are needed according to an exemplary embodiment. According to one exemplary embodiment, two conductors can each be paralleled with an additional conductor to effectively form two lower-resistance conductors, thereby permitting an extended system link 130. These two lower-resistance conductors can be utilized to transport the commingled power and information signals. The four remaining conductors can be used as two pairs to present the network device 112 selected pair, and simultaneously, but separately, present the corresponding connection means 117 pair, to a test device 133.

The interface circuit 135 can include, for example, accommodations for two LEDs embedded in the system link 130 jack or other suitable type of visual indicators, such as, for example, a green LED for power indication and a yellow LED for a test access indicator. According to an exemplary embodiment, the port module 105 can support a single test access of any of the ninety-six communication circuits, as one of the ninety-six communication circuits can be accessed at any one time. The remaining ninety-five communication circuits can be blocked from access until the current access is discontinued. However, on a system basis, any number of communication circuits can be supported, with any number of accesses supported at any time.

The port module 105 can include an access mode selector circuit 140 for selecting one of a plurality of access modes of the port module 105. The access mode selector circuit 140 is in communication with the controller circuit 125 and the interface circuit 135. The access mode selector circuit 140 is also in communication with the selector matrix circuit 120. The test circuit pairs can be protected through a protection circuit to protect down-stream test devices from potentially damaging over-currents and over-voltages. For example, a 1.25 A fuse can be inserted in each lead of the facility access pair, and a 320V surge absorber can be connected across the pair. Other configurations for the protection circuit can be used.

Port module 105 can support several access modes. In an idle (no access) mode, all communication circuits are passed through the port module 105, connecting the first plurality of ports 110 with the second plurality of ports 115. This state can be maintained while the port module 105 is powered down. In a DC monitor access mode, the front-end relays can be activated, while the selected communication circuit continuity can be maintained via the monitor relays on the side of the first plurality of ports 110 (i.e., the equipment side). The tapped communication circuit pair can be routed to the interface circuit 135. Build-out resistors can be inserted in the test access pair to support a DC monitor access mode with reasonable isolation. In an AC monitor access mode, a monitor transformer included in a monitor access circuit 145, such as a current transformer or the like, can be inserted into the communication circuit under test. In this mode, the accessed communication circuit can be routed from the second plurality of ports 115 (the facility side), through the monitor access circuit 145, then back to the first plurality of ports 110 (the equipment side). The monitor circuit can generate an independent signal from the test circuit, and the signal can be routed to the interface circuit 135. In a split access mode, both pairs of the communication circuit (from the first and second plurality of ports 110, 115) are routed to the interface circuit 135. According to exemplary embodiments, in the split access mode, if circuit continuity is required, it can then be supplied by the appropriate test device 133. However, other monitor access modes can be supported by the port module 105, such as that described in commonly-assigned U.S. patent application Ser. No. 10/632,901, entitled “System and Method for Hitless Monitoring Access of A Communication Circuit,” filed Aug. 4, 2003.

The port module 105 can include a circuit protection circuit 150 in communication with the interface circuit 135 for protecting the port module 105 from power transients. According to exemplary embodiments, the port module 105 receives its power from a power signal received over the communication link portion of the system link 130. For example, the port module 105 can receive a +12V DC supply signal over the communication link portion of the system link 130, although any suitable supply voltage can be received, depending on the power requirements of the port module 105. The circuit protection circuit 150 can provide polarity protection of the power signal, which can be limited with an internal 750 mA fuse or the like, and filtered with a series inductor of appropriate inductance to protect the port module 10 s from voltage transients. However, other configurations of the circuit protection circuit 150 are possible, depending on the power signal supplied to, and the power requirements of, the port module 105. The controller circuit 125 is in communication with the circuit protection circuit 150 for communicating information signals modulated on the power signals transmitted over the communication link portion of the system link 130.

The port module 105 can include a power converter circuit 155 for converting the modulated power signals received on the interface circuit 135 to power suitable to supply the power needs of the port module 105. According to an exemplary embodiment, the port module 105 can use a +12V DC power supply to power, for example, the test bus relays. However, a lower supply voltage may be needed for other components of the port module 105. For example, the controller circuit 125, and buffers used in the port module 105, can require a lower voltage 3.3V supply. Thus, the power converter circuit 155 can include action as a linear regulator to convert the 12V power signal to a 3.3V power signal. However, the power converter circuit 155 can regulate the power signal to any desired lower level signal, depending on the power requirements of the port module 105 and its components.

The system 100 includes a system controller 160 coupled to each of the port modules 105 via the communication link portion of the respective system links 130, and coupled to the test devices 133. According to exemplary embodiments, the system controller 160 provides or otherwise supplies the power signals to the port modules 105 over the communication link portion of the respective system links 130. The system controller 160 can be powered from a single power supply 162 (e.g., a −48 V source) received on power input 163. The voltage feeds to the system controller 160 can be polarity protected, over-voltage protected by a varistor (e.g., a 82 V varistor), and over-current protected with an on-board fuse (e.g., a 1 A fuse). The system controller 160 can also include suitable voltage converters or regulators for converting the voltage received on the power supply 162 to the appropriate level(s) for use by the system controller 160 (e.g., +3.3 V DC and the like) and for distribution to the port modules 105 (e.g., +12 V DC). According to exemplary embodiments, port modules 105 can be powered down when not in use to conserve system resources, while port modules 105 with active tests can have power supplied to them. In the powered down state, a port module 105 can be electrically passive, thereby conforming in this mode, by default, to, for example, mandated Electromagnetic Compatibility (EMC) requirements. The port module 105 can remain powered down until an access within the address space of the port module 105 is requested.

The system controller 160 includes a power controller and communication interface circuit 165 for providing power to each of the port modules 105 and for modulating the power signals to communicate the information signals to each of the port modules 105. According to exemplary embodiments, communication between the system controller 160 and a port module 105, and supply of the power signals from the system controller 160 to the port module 105, is conducted using a single communication link within the system link 130. An information signal communicated between the system controller 160 and the port module 105 can comprise a transmission frame and a start of transmission frame flag. The start of transmission frame flag can be used to reset the input registers and counters of the port module 105 prior to reception of a transmission frame.

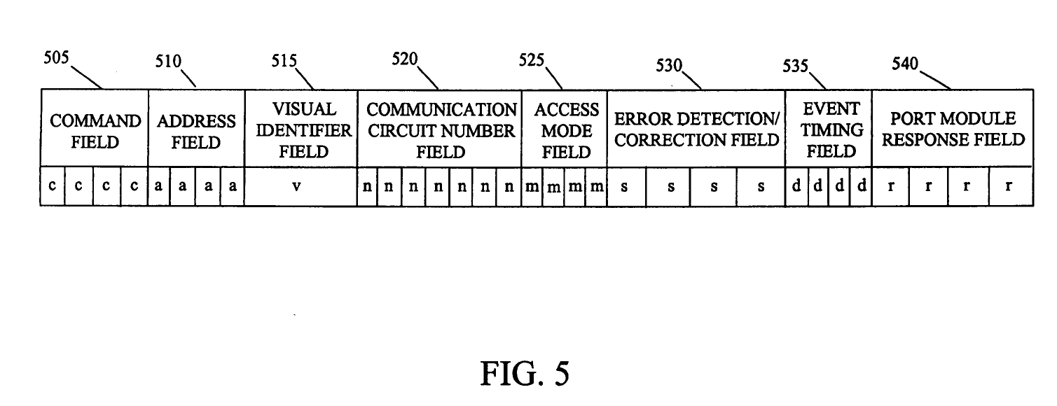

For purposes of illustration and not limitation, FIG. 5 is a diagram illustrating an exemplary 32-bit transmission frame 500, in accordance with an exemplary embodiment of the present invention. The first four bits of the transmission frame 500 can comprise a command field 505, such as, for example, read and write commands. Commands that can be supported include, for example, “write registers” (1001), “read registers” (0101), and “read assembly information” (0110), while all other combinations can be either invalid or used to support additional suitable commands. The next four bits of the transmission frame 500 can comprise a differentiating address field 510 for port modules 105 arranged in a daisy-chain. The next bit of the transmission frame 500 can comprise a visual indicator field 515 to produce a visual indication in the port module 105, such as to turn on or off an LED or the like in the interface circuit 135. For example, a “0” in the visual indicator field 515 can cause a LED to turn off, while a “1” can cause a LED to turn on.

The next seven bits of the transmission frame 500 can comprise a communication circuit number field 520. For ninety-six communication circuits, for example, bit values 0000001 to 1100000 can be used to represent each of communication circuits 1 to 96, 0000000 can be used to represent a “no access,” while 1100001 to 1111111 can be invalid or reserved for future use. The range of bit values used for representing the communication circuits will change, depending on the number of actual communication circuits. The next four bits of the transmission frame 500 can comprise an access mode field 525. For example, a “x1xx” can represent a monitor access mode enable, a “xx1x” can represent a monitor transformer access mode enable, and a “xxx1” can represent a build-out resistor access mode enable (where a “x” is a “don't care” and “1xxx” is unused). The access mode field 525 will vary, depending on the number and types of access modes available for a particular port module 105. The next four bits of the transmission frame 500 can comprise an error detection/correction field 530. For example, the error detection/correction field 530 can comprise a checksum of twenty bits of the transmission frame 500 on a write command, or twelve bits of the transmission frame 500 on a read command. However, the error detection/correction field 530 can comprise any suitable checksum, cyclic redundancy code (CRC) or the like.

According to an exemplary embodiment, the command and address fields 505 and 510 can be generated by the system controller 160 (i.e., always information bits toward the port module 105). In the write mode, the system controller 160 can send control data to the port module 105. In the write mode, the visual indicator field 515, communication circuit number field 520, access mode field 525, and error detection/correction field 530 can be sent toward the port module 105. In the read mode, the port module 105 can dump its current control data to the system controller 160. In the read mode, the visual indicator field 515, communication circuit number field 520, access mode field 525, and error detection/correction field 530 can be output from the port module 105 toward the system controller 160.

The next four bits of the transmission frame 500 can comprise an event timing field 535. As discussed below, the event timing signals can be generated by transitions on the communication link portion of the system link 130. These event timing signals can be asserted by the port module 105 in the write mode transactions for command verification and register assertion (although no data is asserted to the output registers until the checksum is verified). For example, event timing signal one can represent that the checksum has been verified and the port module 105 response has been loaded. Event timing signal two can represent that the visual indicator (e.g., LED) and access modes and tree relays have been asserted. Event timing signal three can represent that a communication circuit access relay has been asserted. Event timing signal four can represent that no action is being taken. Any four values of the bits of event timing field 535 can be used to represent each of the event timing signals. Additional or alternative event timing signals can be used for event timing field 535, depending on, for example, the commands used to control the port module 105.

The remaining four bits of the transmission frame 500 can comprise a port module response field 540. The port module response field 540 is sent by the port module 105 to the system controller 160. For example, if a write operation has occurred, a “1010” response can be sent by the port module 105 to indicate that a write command has been completed (and that the error detection/correction field 530 was verified). A “1100” response can be sent by the port module 105 to indicate that a read command has been completed. A “0110” can be sent to indicate that there was a failure in verifying the error detection/correction field 530. A “0000” can indicate that the port module 105 has not been addressed, while the remaining bit values can be either invalid or reserved for future uses. Additional or alternative bit values can be used for the port module response field 540, depending on, for example, the commands used to control the port module 105. However, transmission frames of other sizes and other configurations can be used to communicate information between the system controller 160 and the port module 105.

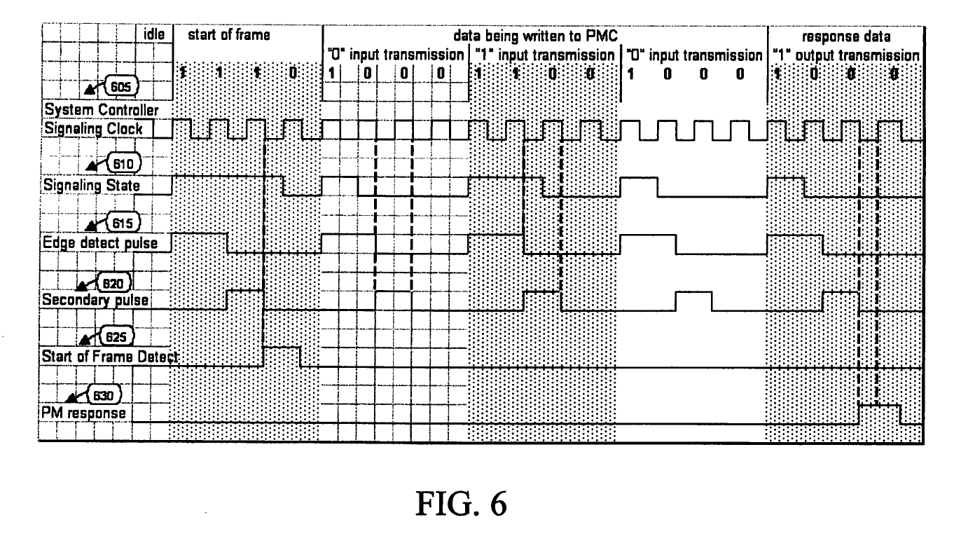

FIG. 6 is a timing diagram illustrating the timing of the communication of transmission frames, in accordance with an exemplary embodiment of the present invention. A system controller signaling clock signal 605 is used internally by the system controller 160 to generate the transmission data pulses. The system controller signaling clock signal 605 does not appear on the port module 105, but is included in the timing diagram as a timing reference only. As noted previously, the power feed to the port module 105 also acts as its communication medium. The +12V power feed to the port module 105 is toggled by the system controller 160 (i.e., the power feed is switched on and off) to produce data bits for transmission to the controller circuit 125 of the port module 105. The signaling state signal 610 can be the logical inverse of the power feed of the port module 105 (e.g., when the power feed is at +12V, the controller circuit 125 “sees” a logical 0 (or logical de-assertion) on its input data pin, and when the power feed is off, the controller circuit 125 “sees” a logical 1 (or a logical assertion)).

According to an exemplary embodiment, data transmission from the system controller 160 to the port module 105 can be conducted through a pulse-width modulation technique, or the like, applied to the power signals supplied from the system controller 160 to the port module 105. Each data bit sent from the system controller 160 to the port module 105 can have a period of four master clock cycles. The data interpreted by the port module 105 can be determined by the width of the generated pulse as follows: a 1-cycle pulse width can represent a Data 0; a 2-cycle pulse width can represent a Data 1; and a 3-cycle pulse width can indicate a start of transmission frame flag. When the port module 105 sees a transition from low-to-high on the signaling state signal 610, the edge detect pulse signal 615 can be activated. The signaling edge detect pulse signal 615 can begin to charge an RC timing circuit on the port module 105 board. When the RC timing circuit reaches a logic-high trip-level, the signaling edge detect pulse signal 615 can be de-activated, and the secondary pulse signal 620 is activated. The secondary pulse signal 620 can remain active until the RC timing circuit discharges below a logic-low trip level (e.g., a Schmitt trigger gate or the like can be used for level tripping).

When the port module 105 is to receive data, the state of the communication link portion of the system link 130 can be read by the port module 105 on the falling edge of the signaling edge detect pulse signal 615 and interpreted as a logical 1 or 0. The state of the communication link portion of the system link 130 can also be read on the falling edge of the secondary pulse signal 620. A logical 1 received on the communication link portion of the system link 130 at this latter time can indicate the start of a transmission frame condition, as indicated by start of frame detect signal 625. All input counters and registers of the controller circuit 125 can be reset when the start of transmission frame flag is detected.

When the port module 105 is to send data, the data bits to be sent to the system controller 160 can be logically asserted on the falling edge of the secondary pulse signal 620, resulting in a port module logical response signal 630. The port module logical response signal 630 can be used to control a transistor on the port module 105. The transistor can be used to increase the current load presented to the port module 105 power feed received over the communication link portion of the system link 130. The system controller 160 will detect the current increase on the power feed, and translate the current increase into a logical 1. The port module 105 can thus modulate the power signals to transmit information signals to the system controller 160 via step current variations on the power feed. In an exemplary embodiment, the system controller 160 can sample the port module 105 current at, for example, the rising edge of the fourth interval of the system controller signaling clock 605 to recover the information signals emanating from the port module 105.

The system controller 160 can include a test device matrix circuit 170 for connecting one of the at least one test devices 133 to a port module 105. According to an exemplary embodiment, the system controller 160 can support, for example, two system test busses allowing for two simultaneous and independent test accesses, although any suitable number of test busses can be supported. The test device matrix circuit 170 can use a matrix structure for connecting the active port module 105 to the appropriate test bus and associated test device 133 through relay switching (e.g., two 20-to-1 relay switching matrices according to one exemplary embodiment, although other relay switching matrices can be used). For example, the system controller 160 can include a test bus expander port (e.g., a 96-pin DIN connector or the like) to expand the number of available system test busses using a relay-matrix daughter card or the like.

The system controller 160 can include other suitable electrical and/or electronic components for performing the functions described herein. For example, the system controller 160 can include a PLD (e.g., an Altera 7256 CPLD or any suitable PLD). The system controller 160 can also include a central processing unit (CPU) (e.g., a Motorola MPC852T Quad Integrated Communications Controller clocked by a 10 MHz crystal oscillator, or any other similarly suitable CPU). For example, if an 852T CPU is used, such a CPU contains numerous types of communication ports, including one Serial Peripheral Interface (SPI). According to an exemplary embodiment, communication between the PLD and CPU of the system controller 160 can be conducted via a four-wire SPI (e.g., serial_clock, data_in, data_out, and enable signal). For the SPI, there can be two enabling signals—one for port module communications and one for the internal PLD registers. For example, while the various SPI-PLD enable signals are inactive, messages on the system controller 160 SPI bus can be ignored, and the SPI data out pin can be tri-stated.

According to an exemplary embodiment, when a SPI-PLD register enable signal goes active or is otherwise asserted, the PLD registers can begin accepting data transmissions from the CPU. SPI register reads/writes involve sending an address and then eight data bits. For example, when writing to PLD registers through the SPI interface, first the four-bit address can be transmitted, then the eight bits of data. Alternatively, the PLD can be programmed to have a parallel interface for its internal registers.

According to an exemplary embodiment, a rising edge on a SPI-PLD port module enable signal can start a process for writing to a selected port module 105. The first eight bits of serial data received after the SPI-PLD port module enable signal becomes active can be stored as the module select bits. According to an exemplary embodiment, up to an additional 116 bits (29 bits with 4 bit encoding) can be passed along to the selected port module 105, although the total number of bits can vary depending upon the modulation scheme used. Table 1 illustrates an exemplary port module bit stream.

TABLE 1
Port Module Bit Stream

| Bit | Bit | Bit | Bit | Bit | Bit | Bit | Bit | Bit | |
|---|---|---|---|---|---|---|---|---|---|
| 0 | 1 | 2 | 3 | 4 | 5 | 6 | 7 | 8 | Bit 9-Bit 36 |
| 0 | 0 | 0 | PM | PM | PM | PM | PM | Start | PORT |
| | | | COMM | COMM | COMM | COMM | COMM | Bit | MODULE |
| | | | 4 | 3 | 2 | 1 | 0 | (1) | COMMAND |
| | | | | | | | | | BITS |

In Table 1, bits 3 to 7 (PM_COMM_{—}4 to PM_COMM_{—}0) are used to select or otherwise specify a port module 105 to which the data is to be directed. For example, the system address of a port module 105 can be defined by which physical RJ-45 connection on the system controller 160 to which the port module 105 is connected (via the communication link of the respective system link 130). Bit 8 is the start of transmission frame flag. The “PORT MODULE COMMAND BITS” comprise the fields of the transmission frame 500, as discussed previously. Other configurations of the serial data are possible.

According to an exemplary embodiment, communication between the CPU and the port modules 105 is established via the system controller 160 PLD and the SPI bus. This mode is activated via the SPI-PMC port module enable signal. When this signal is active, the PLD acts as a data pass through, from sender to receiver, after the port module address is received. Data is transferred to the active port module 105 port as specified in the first eight SPI data bits (as illustrated in Table 1). The SPI bit stream from the CPU master creates a pulse width modulated (PWM) signal for the port module 105. The pulse width modulation is accomplished by latching the output data high after a logical 1 is clocked in, and keeping the output data high until a logical 0 is clocked in. Twenty-nine port module 105 command bits can be encoded, as shown in the following Table 2:

TABLE 2
CPU to PMC Communication Encoding Scheme

| | | | | Bit 3 | |
|---|---|---|---|---|---|
| | Bit 0 (msb) | Bit 1 | Bit 2 | (lsb) | Waveform |
| Start of | 1 | 1 | 1 | 0 | [symbol] |
| Frame | | | | | |
| Write 1 | 1 | 1 | 0 | 0 | [symbol] |
| Write 0 | 1 | 0 | 0 | 0 | [symbol] |
| Write 0 | 1 | 0 | 0 | D | [symbol] |

In the Table 2, “D” represents that read-back data is valid on this cycle. According to an exemplary embodiment, no error checking need be performed on the data stream by the system controller 160 PLD. All error detection can be performed by the CPU and port modules 105, utilizing the respective error detection/correction fields in the transmission frames (e.g., checksums).

The system controller 160 can include other suitable electrical and/or electronic components for performing additional functions. For example, the system controller 160 can include an Ethernet interface port 175 for supporting Base 10/100 twisted pair interface media connections. The system controller 160 can include an asynchronous interface port 180 to provide a RS-232 asynchronous port for communication via an external RJ-45 like connector. The system controller 160 can include a test access port for performing boundary scan testing of the CPU and to program the PLD. The test access port can be JTAG compatible and can use, for example, a five signal dedicated interface on the CPU. The system controller 160 can also include a monitor access amplifier. For example, when a communication circuit is accessed in the AC monitor access mode, the system controller 160 can insert a wideband monitor amplifier into the system test bus. This circuit amplifies the current generated from the in-circuit monitor current transformer within monitor access circuit 145 on the port module 105. The monitor access amplifier can mimic the impedance versus frequency characteristics of a suitable transmission-line, so that the current sensed from the test circuit is interpreted to more accurately reflect the power spectrum of the circuit under test. The system controller 160 can also supply the DC current to bias the monitor current transformer within monitor access circuit 145 of the port module 105 (the derived AC current waveform can ride on the DC current carrier). The system controller 160 can also include additional and/or alternative components, such as, for example, any suitable type of memory (e.g., flash memory to store system controller 160 firmware, RAM, ROM, EPROM and the like), a real-time clock, voltage monitors (e.g., to ensure that voltages are properly generated), and the like, depending on the desired characteristics of the system 100.

According to exemplary embodiments, the network device 112 can comprise any suitable type of network element, such as, for example, a DSLAM or the like. The communication circuits can be associated with the network device by, for example, being terminated on or otherwise connected to the DSLAM. The connection means 117 can be any suitable type of connection capable of coupling the port module 105 through an MDF, an intermediate distribution frame (IDF) or the like towards an end user. Although in one embodiment the port module 105 is configured to be connected directly to, for example, a recessed portion of a back (front) plane of a DSLAM like a type of cable connector, the port module 105 can be situated anywhere between the network device 112 and the connection means 117, so long as it can provide a connection for the communication circuits from the DSLAM (i.e., equipment side) to the MDF and/or IDF (i.e., the facility side).

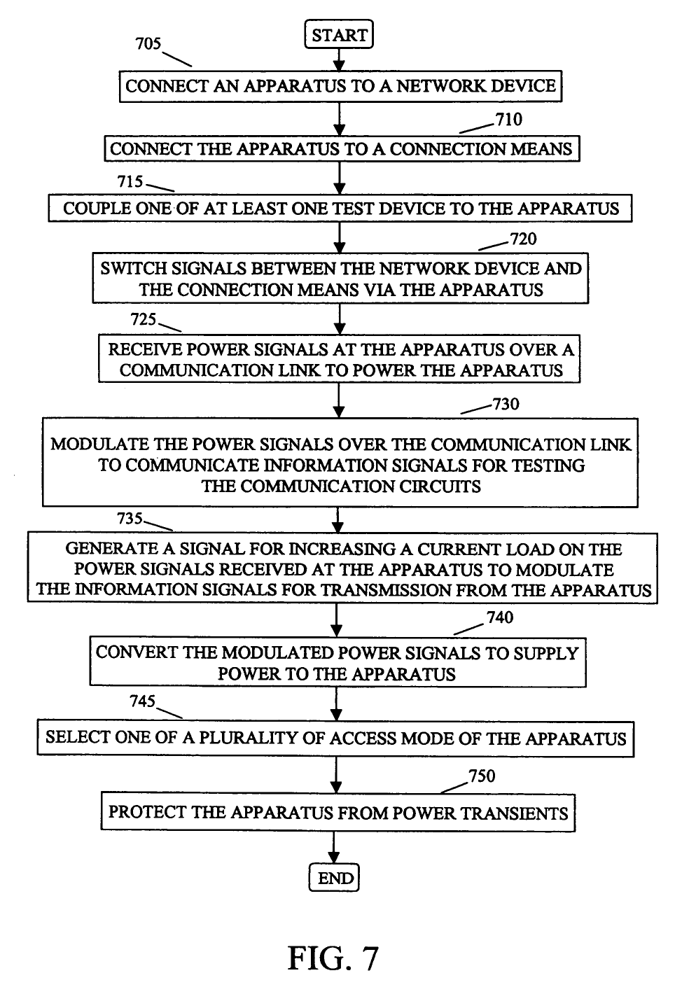

FIG. 7 is a flowchart illustrating steps for providing test access to communication circuits associated with a network device, in accordance with an exemplary embodiment of the present invention. In step 705, an apparatus (e.g., a port module 105) is connected to the network device. In step 710, the apparatus is connected to a connection means. In step 715, one of the at least one test device is coupled to the apparatus. In step 720, signals are switched between the network device and the connection means via the apparatus. In step 725, power signals are received at the apparatus over a communication link to power the apparatus. In step 730, the power signals are modulated over the communication link to communicate information signals for testing the communication circuits. According to an exemplary embodiment, an information signal can comprise a transmission frame. The transmission frame can comprise, for example, a command field, an address field, a visual identifier field, a communication circuit number field, an access mode field, an error detection/correction field, an event timing field, an apparatus response field, and any other suitable fields. The information signal can also include a start of transmission frame flag.

According to an exemplary embodiment, the information signals received over the communication link can comprise pulse-width modulated power signals. In step 735, a signal is generated for increasing a current load on the power signals received at the apparatus to modulate the information signals for transmission from the apparatus. In step 740, the modulated power signals are converted to supply power to the apparatus. In step 745, one of a plurality of access modes of the apparatus is selected. For example, the plurality of access modes can comprise a split access mode, an AC monitor access mode, a DC monitor access mode or any other suitable test access modes. In step 750, the apparatus is protected from power transients.

Exemplary embodiments of the present invention can be in conjunction with, for example, communications testing equipment for testing communications circuits, such as, for example, xDSL circuits, particularly where space and cabling restrictions for adding testing equipment are severe. Exemplary embodiments of the present invention can be embodied, in whole or in part, in hardware, firmware, any other type of electronic circuitry, software, or any combination thereof.

Exemplary embodiments of the present invention can substantially simplify installation procedures for test access equipment and reduce installation costs, particularly with respect to the size, length and routing of cabling to support such test access equipment. For example, exemplary embodiments can allow the elimination of the added loop circuit cabling between the network device and an access element required in conventional schemes, the elimination of the rerouting of the network-device-to-distribution-frame loop circuit cabling in favor of a minor re-connection near the network device, and the elimination of separate power and communication circuit wiring to each access element, among other features.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents, and publications discussed above are hereby incorporated herein by reference in their entireties.

What is claimed is:

1. An apparatus for providing test access to communication circuits associated with a network device, comprising:
a first plurality of ports,
wherein the first plurality of ports are configured to couple the apparatus to the network device;
a second plurality of ports,
wherein the second plurality of ports are configured to couple the apparatus to a connection means;
a selector matrix module in communication with the first and second plurality of ports,
wherein the selector matrix module is configured to switch signals between the network device and the connection means; and
a controller module in communication with the selector matrix module,
wherein the apparatus is configured to receive power signals over a communication link for powering the apparatus, and
wherein the controller module is configured to modulate the power signals over the communication link to communicate information signals for testing the communication circuits.

2. The apparatus of claim 1, comprising:
an interface module in communication with the controller module and the communication link for receiving the power signals and for communicating the information signals from the apparatus.

3. The apparatus of claim 1, comprising:
a system controller,
wherein the system controller is coupled between the apparatus and the at least one test module.

4. The apparatus of claim 3, wherein the system controller provides the power signals to the apparatus over the communication link.

5. The apparatus of claim 3, wherein an information signal communicated between the system controller and the apparatus comprises a transmission frame.

6. The apparatus of claim 5, wherein the transmission frame comprises at least a command field, an address field, a visual indicator field, a communication circuit identifier field, an access mode field, an error detection/correction field, an event timing field and an apparatus response field.

7. The apparatus of claim 5, wherein the information signal communicated between the system controller and the apparatus comprises a start of transmission frame flag.

8. The apparatus of claim 3, wherein the system controller comprises:
a power controller and communication interface module for providing power to the apparatus and for modulating the power signals to communicate the information signals to the apparatus.

9. The apparatus of claim 3, wherein the system controller comprises:
a test bus matrix module for connecting one of the at least one test device to the apparatus.

10. The apparatus of claim 1, wherein the information signals received over the communication link comprise pulse-width modulated power signals.

11. The apparatus of claim 1, wherein the controller module is configured to generate a signal for increasing a current load on the power signals received by the apparatus to modulate the information signals for transmission from the apparatus.

12. The apparatus of claim 1, wherein the controller module comprises a programmable logic device.

13. The apparatus of claim 12, comprising:
a connector module for providing programmable access control to the programmable logic device.

14. The apparatus of claim 1, comprising:
a power converter module for converting the modulated power signals to supply power to the apparatus.

15. The apparatus of claim 1, comprising:
an access mode selection module for selecting one of a plurality of access modes of the apparatus.

16. The apparatus of claim 15, wherein the plurality of access modes comprises a split access mode, an AC monitor access mode and a DC monitor access mode.

17. The apparatus of claim 1, comprising:
a circuit protection module for protecting the apparatus from power transients.

18. The apparatus of claim 1, comprising:
a monitor transformer.

19. The apparatus of claim 1, wherein the network device comprises a digital subscriber line access multiplexer (DSLAM).

20. The apparatus of claim 1, wherein the connection means couples the apparatus through a main distribution frame towards an end user.

21. A system for providing test access to communication circuits associated with network devices, comprising:
at least one port module,
wherein each port module comprises:
at least one of a first port configured to connect the port module to a network device;
at least one of a second port configured to connect the port module to a connection means;
a selector matrix circuit in communication with the first and second ports configured to switch signals between the network device and the connection means; and
a port module controller in communication with the selector matrix circuit; and
a system controller in communication with at least one test device and each port module,
wherein the system controller is configured to provide power signals to each port module over a respective communication link and for modulating the power signals to communicate information signals to each port module for testing the communication circuits.

22. The system of claim 21, wherein each port module comprises:
an interface circuit in communication with the port module controller and a communication link for receiving the power signals and for communicating the information signals from the port module.

23. The system of claim 21, wherein an information signal communicated between the system controller and each port module comprises a transmission frame.

24. The system of claim 23, wherein the information signal communicated between the system controller and each port module comprises a start of transmission frame flag.

25. The system of claim 21, wherein the information signals communicated over the communication link by the system controller comprise pulse-width modulated power signals.

26. The system of claim 21, wherein the port module controller is configured to generate a signal for increasing a current load on the power signals received from the system controller over the communication link to modulate the information signals for transmission to the system controller.

27. An apparatus for providing test access to communication circuits associated with a network device, comprising:
a first plurality of port means for coupling the apparatus to the network device;
a second plurality of port means for coupling the apparatus to a connection means;
a selector means in communication with the first and second plurality of port means for switching signals between the network device and the connection means; and
a controller means in communication with the selector means for controlling the apparatus,
wherein the apparatus is configured to receive power signals over a communication link for powering the apparatus, and
wherein the controller means is configured to modulate the power signals over the communication link to communicate information signals for testing the communication circuits.

28. A system for providing test access to communication circuits associated with network devices, comprising:
at least one port module means,
wherein each port module means comprises:
at least one of first port means for coupling the port module means to a network device;
at least one of second port means for coupling the apparatus to a connection means;
a selector means in communication with the first and second port means for switching signals between the network device and the connection means; and
a port module controller means in communication with the selector means for controlling the port module means; and
a system controller means in communication with at least one test means and each port module means for providing power signals to each port module means over a respective communication link and for modulating the power signals to communicate information signals to each port module means for testing the communication circuits.

29. A method of providing test access to communication circuits associated with a network device, comprising the steps of:
connecting an apparatus to the network device;
connecting the apparatus to a connection means;
switching signals between the network device and the connection means via the apparatus;
receiving power signals at the apparatus over a communication link to power the apparatus; and
modulating the power signals over the communication link to communicate information signals for testing the communication circuits.
